(19) United States
(12) Patent Application Publication
(10) Pub. No.: US 2012/0028204 A1
(43) Pub. Date: Feb. 2, 2012

(54) CORRECTION OF ALVEOLAR CLEFT WITH CALCIUM-BASED BONE GRAFT MATERIALS

(76) Inventor: Spiros A. Lazarou, Kifisia (GR)

(21) Appl. No.: 13/195,568

(22) Filed: Aug. 1, 2011

Related U.S. Application Data
(60) Provisional application No. 61/369,774, filed on Aug. 2, 2010.

(51) Int. Cl. A61C 19/06; A61D 5/00

(52) U.S. Cl. 433/1; 433/215

(57) ABSTRACT

The present disclosure describes the use of calcium-based bone graft material in patients with, for example, congenital alveolar clefts. Calcium-based bone graft material facilitates the primary alveolar cleft repair in relation to the secondary grafting. Calcium bone graft materials in secondary alveolar cleft grafting may also be facilitated.

Claim of Priority under 35 U.S.C. §119

The present Application for Patent claims priority to Provisional Application No. 61/369,774 entitled “Correction of Alveolar Cleft with Calcium-Based Bone Graft Materials” filed Aug. 2, 2010, expressly incorporated by reference herein.

### TECHNICAL FIELD

The present invention is directed to synthetic bone graft material for use in applications requiring tooth eruption.

### BACKGROUND

The use of synthetic bone graft material is generally known. Tooth eruption through such a material has never been shown to successfully occur. Alveolar cleft repair, in particular, is typically performed by iliac crest bone graft prior to secondary tooth eruption. For this reason, a synthetic bone graft material through which tooth eruption can occur, particularly in connection with alveolar cleft repair, is very much desirable.

### BRIEF DESCRIPTION OF THE DRAWINGS

FIG. 1 shows a preoperative image of right alveolar cleft.

FIG. 2 shows a clinical view of a surgical site comprised of bone defect with closure of nasal and oral mucosa.

FIG. 3 shows an intraoperative photo with maximal placement of pellets made of calcium-sulfate based material in an alveolar cleft.

FIG. 4 shows closure of the flaps in FIG. 3 using absorbable suture.

FIG. 5 shows post-operative results seven years after bone substitution with calcium sulfate based material.

FIG. 6 is a postoperative dental scan seven years after bone substitution with calcium sulfate based material of same patient.

FIG. 7 shows postoperative results of another patient in year five.

FIG. 8 shows postoperative results of previous patient in year five.

FIG. 9 shows postoperative results of another patient in year seven.

FIG. 10 shows postoperative results of previous patient in year seven.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well known structures and devices are shown in block diagram form in order to avoid obscuring the novelty of the exemplary embodiments presented herein.

The present disclosure describes the use of synthetic bone graft material to facilitate tooth eruption. In one exemplary embodiment, a calcium-based bone graft material was used for successful surgical correction of alveolar cleft repair involving tooth eruption through this same calcium-based bone graft material. The discovery that synthetic bone grafting can result in tooth eruption provides significant treatment and cost advantages for patients, particularly in comparison to autologous bone graft techniques. An exemplary calcium-based bone graft material for use as a synthetic bioabsorbable bone graft material is Stimulan® manufactured by Biocomposites, based in Staffordshire, U.K.

Experimental results have shown that teeth do erupt when using calcium-based synthetic bone graft material to acquire normal functioning bone in the alveolar ridge.

Bone grafting the alveolar cleft is critical to correcting defects. The benefits of this have adequately been previously described and include stabilization of the maxillary arch, elimination of oronasal fistulae, creation of bony support for subsequent tooth eruption, and reconstruction of the hypoplastic pyriform aperture and soft tissue nasal base support.

While secondary repair just prior to eruption of the secondary tooth with iliac crest bone graft is widely recognized as a first approach technique, controversy exists with regard to the optimum timing of any surgery.

Further, it is well known that significant benefits derive from grafting prior to primary tooth eruption in early childhood and that prevention of transverse maxillary collapse and distortion between the upper and lower arches may reduce orthodontic treatment time as well as the need for orthognathic surgery.

Early obliteration of the alveolar oronasal fistula with its concomitant liquid escape, oral hygiene and emotional issues in this childhood period are additional known benefits. The use of more conservative techniques that avoid dissection of important growth centers has overcome concerns over possible midfacial growth impairment. Additionally, good results have been also described with onlay rib and calvarial grafts.

The further discovery described herein of a synthetic bone graft material to support tooth eruption obviates the need for conventional autologous bone grafting as teeth have been shown to erupt through what appears to be normal alveolar bone growth stimulated by the placement of calcium-based bone graft material (such as material based from calcium sulfate or calcium phosphate or equivalents) in the alveolar cleft.

Experimental Results

Ten consecutive patients with complete cleft lip, palate and unilateral alveolar cleft with reasonably aligned arches were grafted beginning in January of 2003 through March of 2007. The mean age of surgery was 10.4 months. Follow up ranged from three to seven years. Radiological evaluation of alveolar ridge was performed at the age of four.

All ten patients were operated on by the same surgeon using the same technique, i.e. conservative elevation of nasal, oral and anterior alveolar mucosal flaps around the cleft, closure of nasal and oral flaps, placement of 1-3cc of calcium-based graft material paste or crystals in the pocket and closure of the anterior alveolar mucosa. All ten patients healed without complication. Clinical evaluation revealed a well healed arch with primary tooth growth in the area of the previous cleft. Adequate normal bone formation and often a descending secondary tooth were radiologically confirmed.

The patients in the subject study (all children) were operated on between January of 2003 and March of 2007. The patients were consecutive and with complete cleft lip and palates with unilateral alveolar clefts.

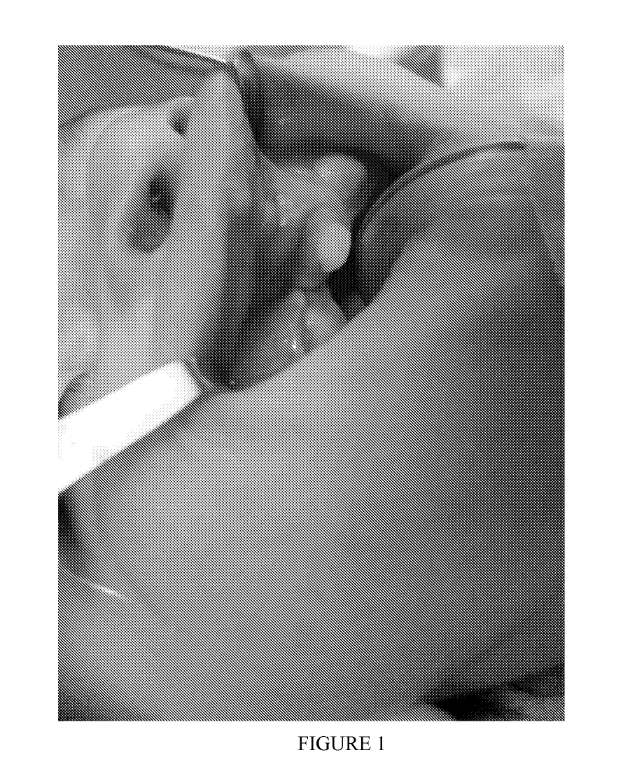

FIG. 1 shows a preoperative image of right alveolar cleft.

The ten patients were comprised of seven boys and three girls. Of these, one had a bilateral cleft lip but with unilateral alveolar cleft. Six clefts were left and four were right. Arches were reasonably well aligned. No other exclusion criteria were used. Furthermore, aside from the clinical outcome, a panorex and an occlusal x-ray were performed approximately at the age of four years when the child could cooperate in order to evaluate the alveolar bone growth and the existing not erupted teeth.

Stimulan® was used as the calcium-based bone graft material in all ten patients, which, by the way, were operated on by the inventor.

Stimulan® consists of calcium sulfate based material powder. This powder was diluted to form an injectable paste. Calcium sulfate based pellets were also used alone or in combination with similar success, as shown in Table 1. Calcium phosphate and like calcium based material (in powder, pellet or other form) may also be used in lieu of calcium sulfate. In fact, calcium phosphate based material was employed under similar experimental conditions and showed similar in tooth eruption capability as calcium sulfate.

TABLE 1
Results of alveolar cleft correction with calcium sulfate based material in
ten patients

| | Age (months), | | Type of | FU | Tooth |
|---|---|---|---|---|---|
| Patient | sex | Type of defect | material | (years) | eruption |
| 1 | 12, M | UAC, CP, CL | pellets | 7 | present |
| 2 | 11, M | UAC, CP, CL | injectable | 7 | present |
| | | | paste | | |
| 3 | 11, M | UAC, CP, CL | injectable | 5 | present |
| | | | paste/ | | |
| | | | pellets | | |
| 4 | 11, M | UAC, CP, CL | pellets | 5 | present |
| 5 | 10, M | UAC, CP, CL | pellets | 5 | present |
| 6 | 10, F | UAC, CP, CL | injectable | 5 | present |
| | | | paste | | |
| 7 | 10, M | UAC, CP, CL | pellets | 5 | present |
| 8 | 10, F | UAC, CP, CL | injectable | 4 | present |
| | | | paste/ | | |
| | | | pellets | | |
| 9 | 9, F | UAC, CP, CL | injectable | 4 | present |
| | | | paste | | |
| 10 | 10, M | UAC, CP, CL | pellets | 4 | present |

Abbreviations:
M = male,
F = female,
FU = follow-up,
UAC = unilateral alveolar cleft,
CL = cleft lip,
CP = cleft palate

Back to the study, once normal consistency was achieved, the material was placed in the bed of the alveolar cleft pocket and allowed to dry.

As alternative preparations, calcium-based bone graft material could have been injected, and/or calcium sulfate pellets may have been used directly without waiting to dry out.

In the experimental treatments discussed, prior to the placement of the calcium-based bone graft material, nasal and oral mucosas were first sutured.

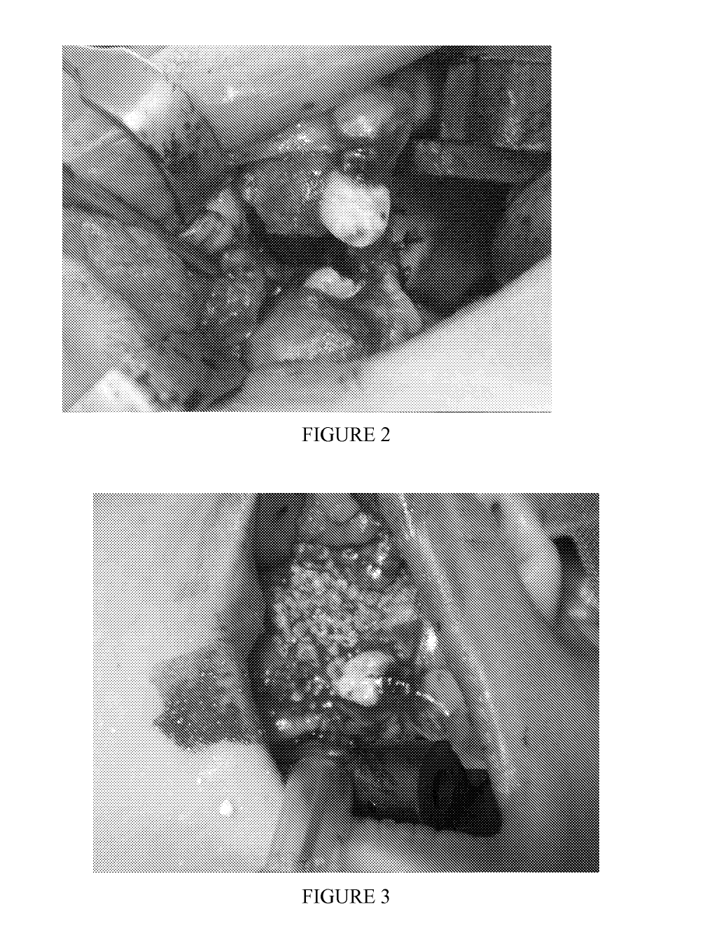

FIG. 2 shows a clinical view of a surgical site comprised of bone defect with closure of nasal and oral mucosa.

FIG. 3 shows an intraoperative photo with maximal placement of pellets of calcium sulfate based material in an alveolar cleft. This is shown after the graft is placed and dried.

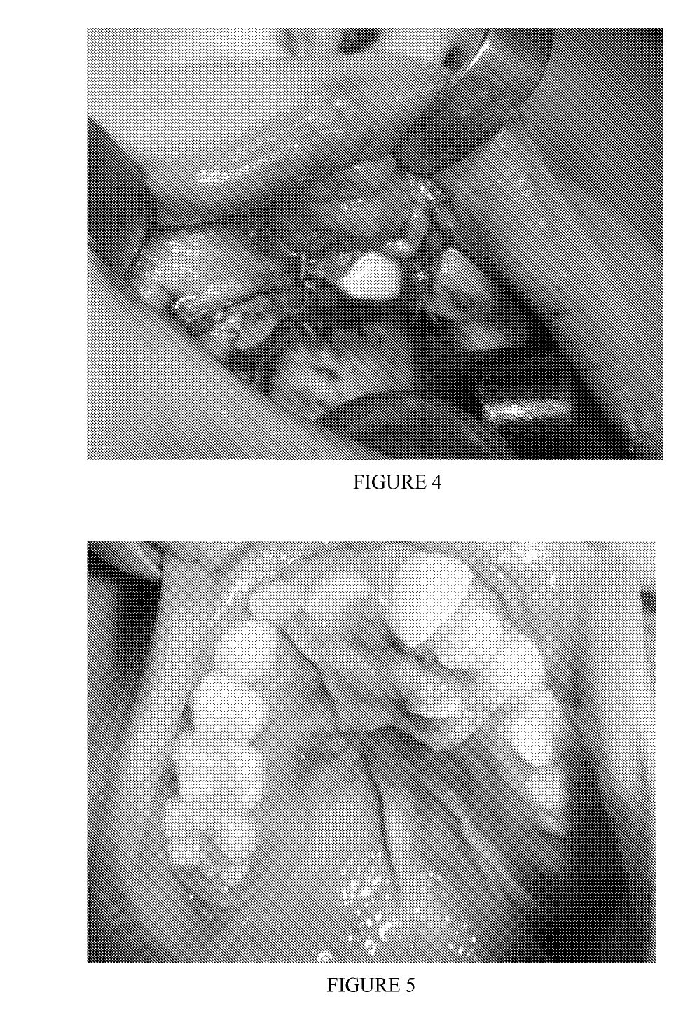

FIG. 4 shows closure of the flaps in FIG. 3 using absorbable suture.

The technique involves conservative elevation of the nasal and oral mucosa enough to create an adequate pocket approximating the desired size of the alveolar ridge in that area. Intravenous antibiotics consisting of a broad spectrum cephalosporin was given for twenty four (24) hours. The patients went home the next day on per os antibiotic therapy for four more days.

Surgery was uncomplicated in all ten patients. Mean age of surgery was 10.4 months. Follow up ranged from 3 to 7 years. Mean follow up was 5.1 years. All patients maintain good contour and without clinical evidence of significant resorption of the implant turned bone. No infection or any other complication related to the material was observed. Moreover, there was a stable maxilla, reasonable arch formation and excellent tooth eruption. The postoperative radiologic evaluation revealed adequate bone formation with descending secondary tooth visible in the older patients. Even though the patients will certainly need orthodontic treatment, none of the patients required reoperation. Deciduous tooth eruption in the cleft area was indeed delayed as has been previously noted in clefts by others.

The primary reason for the use of autologous bone grafting has been the concern that no bone graft material has the dynamics necessary for later tooth eruption. An ideal material for alveolar cleft defects, therefore, must closely approximate normal physiology of bone formation. It has been shown that a calcium-based biosynthetic material can support both structure and function of bone restoration and exhibit the following necessary properties: biocompatibility, stability (lifetime duration), mechanical strength, capability of ingrowth, pliability (moldable to implant site), compatible with imaging studies and resistance to infection. As such, calcium-based graft material could become a widely used bone graft material in alveolar arch defects.

Further, an inorganic, osteoconductive substance such as calcium sulfate acts primarily as a space filler, restoring morphological contour, preventing ingrowth of soft tissue and providing an osteoconductive matrix for the ingrowth of blood vessels. Histologically, new bone remodeled from calcium-based graft material can become contiguous with adjacent native bone, and thus indistinguishable from autogenous bone; filling the grafted sites in a period of 24 weeks.

It is known that safe and reliable alveolar bone regeneration is possible using recombinant human bone morphogenetic protein (rhBMP). The great moldability of calcium sulfate is, in this regard, equal to or better than cancellous bone. Calcium-based graft material may be preparated thin enough to allow its being injected in case of resorption.

During the subject study, none of the patients showed any evidence of foreign body reaction to the implant material or infection at the implant site. This was assessed by physical exam and proven by relevant imaging studies.

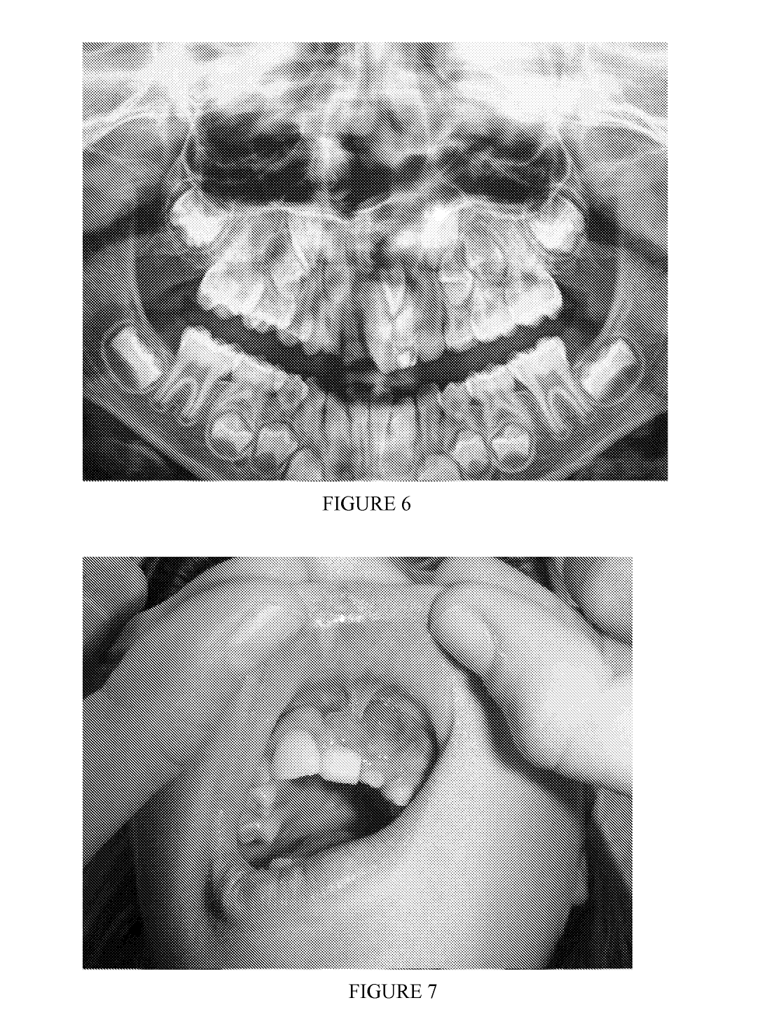

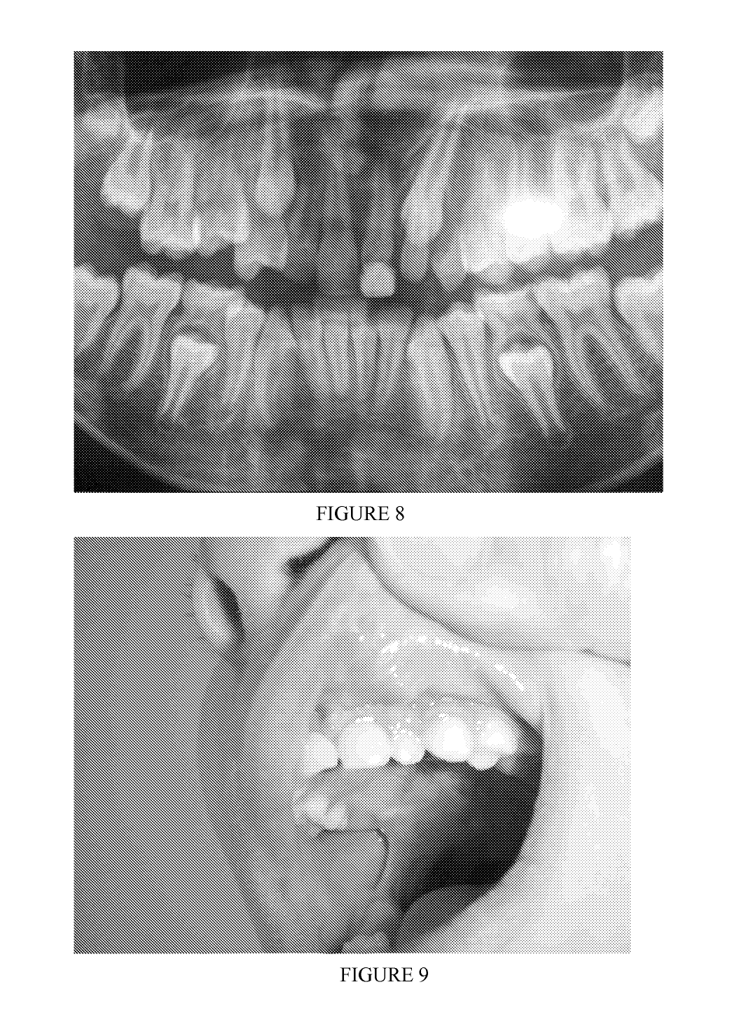

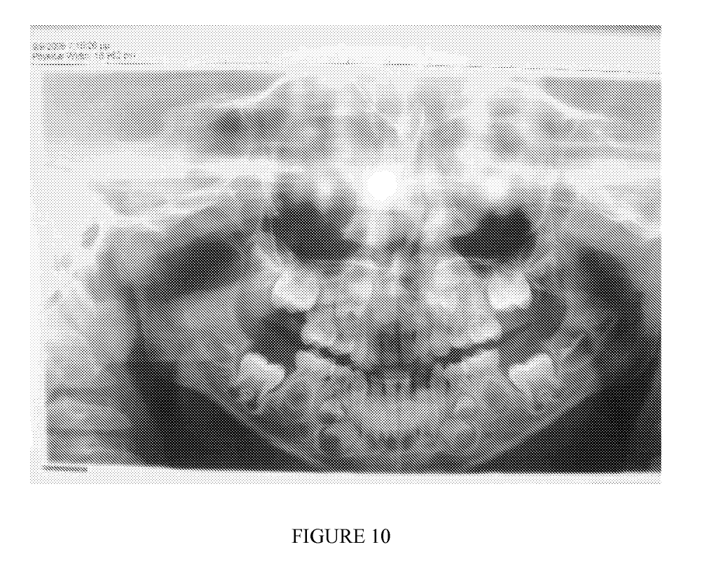

FIG. 5 shows post-operative results seven years after bone substitution with calcium sulfate based material. FIG. 6 is a postoperative dental scan seven years after bone substitution with calcium sulfate based material of the previous patient. FIG. 7 shows postoperative results of a patient in year five. FIG. 8 shows postoperative radiologic results of the previous patient in year five. FIG. 9 shows postoperative results of a patient in year seven. FIG. 10 shows radiologic results of the previous patient in year seven.

During study and in other uses, microfragmentation has not been encountered in using calcium-based bone graft material. Whatever resorption may have occurred was not clinically significant.

The study successfully established that tooth eruption can occur through a synthetic calcium based bone graft in alveolar clefts and prior to deciduous tooth eruption. The use of calcium-based bone graft material has significant advantages over other biomaterials and autologous tissue in the correction of alveolar clefts. The fact that Stimulan®, for example, is available off the shelf is a great advantage as it obviates the need for a donor site, reduces anesthesia time, reduces morbidity and decreases costs. Biocompatibility and resistance to infection seem to be additional benefits.

In conclusion, the application of calcium-based bone graft material in patients with congenital alveolar clefts seems to be very promising. For same reasons, it is believed very likely to facilitate primary alveolar cleft repair in relation to the secondary grafting, as well as for secondary alveolar cleft repair.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of grafting a region of tooth eruption involving filling the region with a synthetic bone graft material.

2. The method of claim 1, wherein the synthetic bone graft material is a calcium-based bone graft material.

3. The method of claim 2, wherein the synthetic bone graft is for alveolar bone growth in the region of tooth eruption.

4. The method of claim 2, wherein the calcium-based bone graft material is a calcium sulfate based material.

5. The method of claim 4, wherein the calcium sulfate based material is Stimulan®.

6. The method of claim 2, wherein the calcium-based bone graft material is a calcium phosphate based material.

7. A compound comprised of a synthetic bone graft material for non-human use applications requiring tooth eruption.

8. The compound of claim 7, wherein the synthetic bone graft material is a calcium-based bone graft material.

9. The compound of claim 8, wherein the synthetic bone graft is for alveolar bone growth in the region of tooth eruption.

10. The compound of claim 8, wherein the calcium-based bone graft material is a calcium sulfate based material.

11. The compound of claim 10, wherein the calcium sulfate based material is Stimulan®.

12. The compound of claim 8, wherein the calcium-based bone graft material is a calcium phosphate based material.
